(19) United States
(12) Patent Application Publication
(10) Pub. No.: US 2008/0224976 A1
(43) Pub. Date: Sep. 18, 2008

(54) Method and apparatus for temporally/spatially randomly dithering and liquid crystal display using the same

(76) Inventors: Jae-chul Lee, Seoul (KR); Jong-seon Kim, Seongnam-si (KR); Young-min Choi, Seoul (KR); Keun-ho Ryu, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 12/073,935

(22) Filed: Mar. 12, 2008

(30) Foreign Application Priority Data
Mar. 13, 2007 (KR) 10-2007-0024675

(51) Int. Cl. G09G 3/36

(52) U.S. Cl. 345/89

(57) ABSTRACT

A method of temporally and/or spatially randomly dithering, to facilitate converting an input M-bit subpixel signal into an (M−N)-bit subpixel signal, may include spatially and/or temporally randomly generating a dithering mask pattern satisfying a condition that a spatial mean and/or a temporal mean of an image signal before dithering matches a spatial mean and/or a temporal mean of the image signal after dithering, respectively, and converting the M-bit subpixel signal into the (M−N)-bit subpixel signal using the dithering mask pattern.

### BACKGROUND OF THE INVENTION

1. Field of the Invention

Embodiments relate to a method of and apparatus for processing image data. More particularly, embodiments relate to a dithering method and apparatus for dispersing an energy spectrum that otherwise would concentrate in a predetermined frequency band.

2. Description of the Related Art

In an image data processing apparatus, the number of bits available to express pixel data typically exceeds the number of bits of pixel data available to display the pixel data on a display apparatus. As a result, there is bit reduction process by which quantization error is introduced. For example, if 8 bits are available to express pixel data in an image data processing apparatus and 6 bits are available to display the pixel data on a display apparatus, then the conversion from 8-bit image data into 6-bit image data will suffer from quantization error. Dithering uses random noise to make the quantization error less perceptible.

According to conventional technology, dithering is performed based on a dither table of noise values. The two least significant bits (LSBs) of an input subpixel signal are used to index into the dither table. Based upon the values of the two LSBs, a dithering pattern for a given group of four frames is determined. As a result, regular changes appear in the dither pattern applied to the N^{th} frame and (N+1)^{th} frame. Relative to a given pixel at a position fixed in time, a weight may be activated during a cycle which is half the cycle of a frame frequency. In terms of a frequency characteristic spectrum resulting from the conventional dithering technique, energy concentrates in a predetermined band located at a frequency about half that of the frame frequency, causing the display panel to flicker.

### SUMMARY OF THE INVENTION

Embodiments of the present invention are therefore directed to a random temporal and/or spatial dithering method and apparatus, and an LCD apparatus incorporating the same, which substantially overcome one or more of the problems due to the limitations and disadvantages of the conventional art.

It is therefore a feature of an embodiment of the present invention to provide a random temporal and/or spatial dithering method and apparatus which can reduce, if not prevent concentration of energy in a predetermined frequency band of a frequency characteristic spectrum.

At least one of the above and other features and advantages of the present invention may be realized by providing a method of at least one of temporally and spatially randomly dithering by which an input M-bit subpixel signal is converted into an (M−N)-bit subpixel signal. The method may include at least one of spatially and temporally randomly generating a dithering mask pattern satisfying a condition that a spatial mean and/or a temporal mean of an image signal before dithering matches a spatial mean and/or a temporal mean of the image signal after dithering, respectively, and converting the M-bit subpixel signal into the (M−N)-bit subpixel signal using the dithering mask pattern.

A frame may be organized into macro pixels, each macro pixels may include pixels, each pixel may include subpixels, and N may be an integer greater than or equal to two. At least one of spatially and temporally randomly generating the dithering mask pattern may include temporally randomly generating a frame offset value for each frame of 2^{N} frames, generating a masking pattern by performing at least the following, randomly selecting a respective value from a set {0, 1, 2, . . . , 2^{N}−1} as a mask value corresponding to each subpixel in each macro pixel in a first frame from which the cycle begins, such that the selected mask value does not overlap another mask value in a given macro pixel, and then randomly selecting values, for the 2^{N}−1 remaining frames of the cycle and respective of coordinates of corresponding subpixels in the 2^{N} frames of the cycle, from remaining values in the set {0, 1, 2, . . . , 2^{N}−1} as mask values corresponding to each subpixel, excluding values already selected for subpixels at corresponding coordinates of other frames of the cycle, and such that selected mask values for a given macro pixel in a given one of the 2^{N}−1 remaining frames do not overlap, and forming a 2^{N}-ary dithering mask pattern, by adding the frame offset value to the generated masking pattern.

Generating the frame offset value may include randomly selecting from the set {0, 1, 2, to 2^{N}−1}. A carry value generated when an addition is performed may be discarded. Generating the frame offset generation may include generating a first signal for each 2^{N} frame synchronization signal, generating a random number whenever the first signal is generated, and generating the frame offset value based on the random number generated by the time-axis random number generator.

Converting of the M-bit subpixel signal into the (M−N)-bit subpixel signal may include comparing values of N least significant bits (LSBs) of the input M-bit subpixel signal with the values of the dithering mask pattern corresponding to coordinates at which the input subpixel signal is to be displayed, adding ‘1’ to an (N+1)^{th} LSB of the input subpixels if the comparison result indicates that the values of the N LSBs of the input M-bit subpixel signal are greater than the values of the dithering mask pattern corresponding to the coordinates at which the input subpixel signal is to be displayed, else adding ‘0’ to the (N+1)^{th} LSB, and deleting the values of the N LSBs in the resulting M-bit subpixel signal, thereby generating the (M−N)-bit subpixel signal.

At least one of the above and other features and advantages of the present invention may be realized by providing a computer readable recording medium comprising instructions recorded thereon, execution of which by a computer results in the computer performing the method noted above.

At least one of the above and other features and advantages of the present invention may be realized by providing an apparatus for at least one of temporally and spatially randomly dithering to facilitate converting an M-bit input subpixel signal of a frame into an (M−N)-bit subpixel signal, the apparatus including a dithering mask pattern generation circuit configured to generate, by at least one of spatially and temporally randomly dithering, a dithering mask pattern satisfying a condition that a spatial mean and/or a temporal mean of an image signal before dithering matches a spatial mean and/or a temporal mean of the image signal after dithering, respectively, and a dithering circuit converting the M-bit subpixel signal into the (M−N)-bit subpixel signal using the generated dithering mask patterns.

The frame may be organized into macro pixels. The apparatus may further include a frame offset generation circuit temporally randomly generating a frame offset value for each frame of 2^{N} frames, and a spatial random number generation circuit generating random numbers for each macro pixel of a frame, the dithering mask pattern being based on the frame offset value and the random number corresponding to the macro pixel.

The frame offset generation circuit may include a frame counter counting a frame synchronization signal, thereby generating a first signal for each 2^{N} frame synchronization signal, a time-axis random number generator generating a random number whenever the first signal is generated, and a frame offset generator generating a frame offset value based on the random number generated by the time-axis random number generator. The spatial random number generation circuit may include a display coordinates calculation unit counting a data clock signal, thereby calculating display coordinates, a vertical-axis random number generator generating a random number whenever a line is changed, and a horizontal-axis random number generator generating the random numbers for each macro pixel based on the random number generated in the vertical-axis random number generator. The horizontal-axis random number generator comprises a red subpixel signal horizontal random number generator, a green subpixel signal horizontal random number generator, and a blue subpixel signal horizontal random number generator.

The frame may be organized into macro pixels, each macro pixel may include pixels, each pixel may include subpixels, and N may be an integer greater than or equal to two. The dithering mask pattern generation circuit may include a frame offset generation circuit temporally randomly configured to generate a frame offset value frame of 2^{N} frames, a dither pattern generation unit configured to generate a masking pattern based on the random number generated in the spatial random number generation circuit, by performing at least the following, randomly selecting a respective value from a set {0, 1, 2, . . . , 2^{N}−1} as a mask value corresponding to each subpixel in each macro pixel in a first frame from which the cycle begins, such that the selected mask value does not overlap another mask value in a given macro pixel, and then randomly selecting values, for the 2^{N}−1 remaining frames of the cycle and respective of coordinates of corresponding subpixels in the 2^{N} frames of the cycle, from the remaining values in the set {0, 1, 2, . . . , 2^{N}1} as mask values corresponding to each subpixel, excluding values already selected for subpixels at corresponding coordinates of other frames of the cycle, and such that selected mask values for a given macro pixel in a given one of the 2^{N}−1 remaining frames do not overlap, and an adder configured to add the frame offset value and the masking pattern values, respectively, thereby generating dithering mask pattern values.

The dither pattern generation unit may be configured to select and output one dither pattern, based on the random number output from the horizontal random number generator, from a table storing a plurality of dither patterns sized according to a size of the macro pixels. The adder may discard a carry value that occurs when the adder performs addition.

The dithering circuit may include a data separator dividing the input M-bit subpixel signal into most significant bits (MSBs) [M−1:N] and LSBs [N−1:0], a comparator comparing the dithering mask pattern values with corresponding LSBs [N−1:0] of subpixels in the macro pixels, and if the values of the LSBs [N−1:0] are greater than the values of the dithering mask pattern, outputting ‘1’, else outputting ‘0’, and an adder adding the output value of the comparator to the LSB of the MSBs [M−1:N], thereby outputting the dithered (M−N)-bit subpixel signal.

The dithering mask pattern generation circuit may include a dithering mask pattern generation circuit for a red subpixel signal, a dithering mask pattern generation circuit for a green subpixel signal, and a dithering mask pattern generation circuit for a blue subpixel signal. The dithering circuit may include a dithering circuit for a red subpixel signal, a dithering circuit for a green subpixel signal, and a dithering circuit for blue subpixel signal.

At least one of the above and other features and advantages of the present invention may be realized by providing a liquid crystal display (LCD) apparatus including an LCD panel in which a plurality of gate lines and a plurality of data lines are arranged intersecting each other in matrix form, the LCD panel being operable to display an image, in units of pixels, corresponding to a pixel data voltage provided to a data line according to a gate pulse provided to a gate line, a controller configured to perform at least the following, generating a gate control signal for selecting the gate line and a data control signal for outputting pixel data in units of data lines, at least one of spatially and temporally randomly generating a dithering mask pattern satisfying a condition that a spatial mean and/or a temporal mean of an image signal before dithering matches a spatial mean and/or a temporal mean of the image signal after dithering, respectively, and performing dithering using the dithering mask pattern, thereby converting the M-bit subpixel signal of a frame into the (M−N)-bit subpixel signal and outputting the converted signal, a gate driving unit providing a gate driving pulse to a gate line selected according to the gate control signal, and a data driving unit generating a voltage corresponding to the (M−N)-bit subpixel signal and providing the generated voltage to the data line.

The controller may include a frame offset generation circuit configured to temporally randomly generate a frame offset value in units of 2^{N} frames, a spatial random number generation circuit configured to generate random numbers for each macro pixel of a frame, a dithering mask pattern generation circuit configured to at least one of spatially and temporally randomly generate a dithering mask pattern for each macro pixel satisfying a condition that the spatial mean and/or the temporal mean of an image signal before dithering matches the spatial mean and/or the temporal mean of the image signal after dithering, respectively, based on the frame offset value and the random number corresponding to the macro pixel, and a dithering circuit configured to convert the M-bit subpixel signal into the (M−N)-bit subpixel signal using the generated dithering mask pattern.

### BRIEF DESCRIPTION OF THE DRAWINGS

The above and other features and advantages of embodiments will become more apparent to those of ordinary skill in the art by describing in detail exemplary embodiments thereof with reference to the attached drawings, in which:

FIG. 1 illustrates a conceptual diagram of a method of dithering according to an exemplary embodiment of the present invention;

FIG. 2 illustrates a flowchart of a method of randomly temporally and/or spatially dithering according to another exemplary embodiment of the present invention;

FIG. 3 illustrates a block diagram of a structure of a circuit for generating a dithering mask pattern in a temporal and/or spatial random dithering apparatus according to another exemplary embodiment;

FIG. 4 illustrates a block diagram of a structure of a circuit for dithering in a temporal and/or spatial random dithering apparatus according to another exemplary embodiment;

FIG. 5 illustrates a structure of an LCD apparatus according to an exemplary embodiment;

FIG. 6 illustrates an image output to an LCD when dithering is applied to a gradation pattern according to an exemplary embodiment;

FIG. 7 illustrates a frequency characteristic spectrum in relation to a pixel at a given fixed position that would be achieved when dithering is performed according to an exemplary embodiment;

FIG. 8 illustrates a comparative example of image output to an LCD apparatus when dithering is applied to a gradation pattern according to conventional technology; and

FIG. 9 illustrates a comparative example of a frequency characteristic spectrum in relation to a pixel at a given fixed position that would be achieved when dithering is performed according to the conventional technology.

### DETAILED DESCRIPTION OF THE INVENTION

Korean Patent Application No. 10-2007-0024675, filed on Mar. 13, 2007, in the Korean Intellectual Property Office, and entitled: “Method and Apparatus for Temporally/Spatially Randomly Dithering and Liquid Crystal Display Using the Same,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the exemplary embodiments set forth herein. Rather, these exemplary embodiments are provided so that this disclosure will be thorough and complete, and will fully convey the scope of the invention to those skilled in the art.

In the figures, the dimensions of layers and regions may be exaggerated for clarity of illustration. It will also be understood that when an element is referred to as being “connected to” another element, it may be directly connected or indirectly connected, i.e., intervening elements may also be present. Further, it will be understood that when an element is referred to as being “between” two elements, it may be the only element layer between the two elements, or one or more intervening elements may also be present. Like reference numerals refer to like elements throughout.

In a dithering process for reducing an input signal by N bits (N is an even integer), a dithering mask pattern may be generated, for example, in units of macro pixels, where each macro pixel may include 2^{N/2}*2^{N/2} pixels. A dithering mask pattern may also be set so that dithering may be performed upon macro pixels of different sizes. Each pixel of a given macro pixel may include subpixels, e.g., red(R), green(G), and blue(B) subpixels.

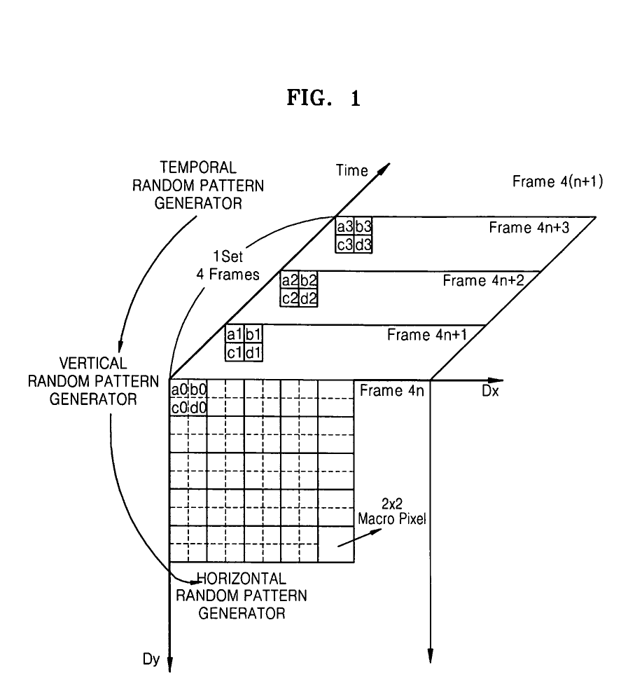

For convenience of explanation, only a dithering method of converting 8-bit data into 6-bit and outputting the converted data will be explained. It should be understood that the present invention is not limited to the circumstance of converting 8-bits into 6-bits. A coordinate system may be set to have the X-axis and Y-axis on a display panel and a time-axis. As illustrated in FIG. 1, dithering may be performed upon units of macro pixels, each of which may be formed of 2×2 pixels.

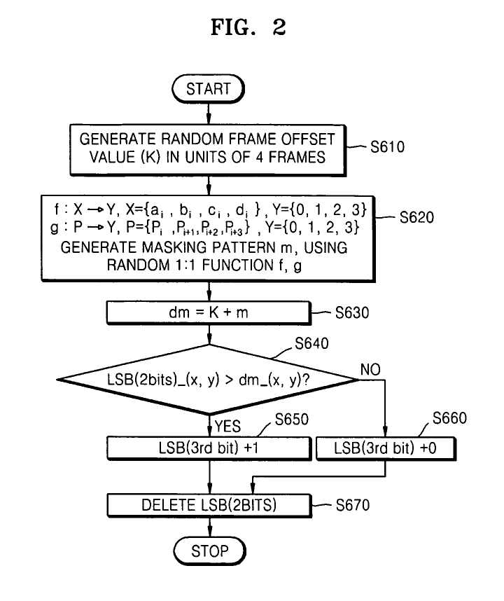

For the method of randomly temporally and/or spatially dithering illustrated in FIG. 2, a frame offset value (K) may be generated in relation to each cycle of a given number of frames, e.g., 2^{N} frames, here, four (4) frames, in operation S610. The frame offset value (K) may be randomly determined as one of the members of the set {0, 1, 2, 3}. Then, in operation S620, a masking pattern (m) may be randomly temporally and/or spatially generated by using a function f and/or a function g, respectively, while satisfying a condition that a spatial mean and/or a temporal mean of an image signal before dithering matches the spatial mean and/or the temporal mean of the image signal after dithering, respectively.

Under the condition that the spatial mean of the input image signal matches the spatial mean of the dithered image signal, an arbitrary pattern value in relation to each macro pixel may be generated using the function f: X→Y. For example, the function f may have the domain X={aₙ, bₙ, cₙ, dₙ} and the codomain Y={0, 1, 2, 3}, where aₙ, bₙ, cₙ and dₙ represent values of pixels at different locations within an n^{th} frame such that aₙ, bₙ, cₙ and dₙ correspond to the same moment in time. For the function f, the domain and the codomain may have a 1:1 correspondence relation. Accordingly, in the generated masking pattern, no overlapping pattern value exists amongst the pixels of a macro pixel.

In performing temporal dithering, an offset may be randomly generated in relation to each frame so that concentration of an energy spectrum in the predetermined frequency band may be reduced, if not prevented. Under the condition that the temporal mean before dithering matches the temporal mean after dithering, an arbitrary pattern value in relation to each cycle of four frames may be generated using the function g: P→Y. For example, the function g may have the domain P={pᵢ, pᵢ₊₁, pᵢ₊₂, pᵢ₊₃} and the codomain Y={0, 1, 2, 3}, where pᵢ, pᵢ₊₁, pᵢ₊₂, and pᵢ₊₃ represent values of pixels at the same location albeit across different frames, i.e., across frame j, frameᵢ₊₁, frameᵢ₊₂ and frameᵢ₊₄. For the function g, the domain and the range may have a 1:1 correspondence relationship. Accordingly, in the generated masking pattern, no overlapping pattern value exists amongst the pixels at spatially identical positions in a unit frame.

Next, in operation S630, a dithering mask pattern (dm) may be generated by adding the masking pattern (m), generated in operation S620, and the frame offset value (K) corresponding to each frame, generated in operation S610. For example, by using a quaternary adder, the frame offset value (K) may be added to the masking pattern (m), thereby generating a quaternary dithering mask pattern. A carry that might occur when the addition is performed may be discarded.

By using the dithering mask pattern (dm) generated as described above, dithering may be performed as follows. In operation S640, N LSB values, e.g., the two least significant of the bit values {LSB(2 bits)_(x,y)}, of an input subpixel signal, e.g., an 8-bit signal, may be compared with the values {dm_(x,y)} of the dithering mask pattern corresponding to the coordinates (x,y) at which the input subpixel signal is to be displayed.

If the comparison result in operation S640 indicates that the two LSB values {LSB(2 bits)_(x,y)} are greater than the values {dm_(x,y)} of the dithering mask pattern, then the value of one, ‘1,’ may be added to a bit {LSB(3rd bit)} immediately next to the two LSBs in operation S650. If the comparison result in operation S640 indicates that the two LSB values {LSB(2 bits)_(x,y)} are equal to or less than the values {dm_(x,y)} of the dithering mask pattern, then the value zero, ‘0,’ may be added to the bit {LSB(3rd bit)} immediately next to the two LSBs in operation S650. After performing operations S650 or S660, the two LSB values of the input 8-bit subpixel signal may be deleted, thereby generating a 6-bit subpixel signal in operation S670. In this way, dithering may be randomly temporally and/or spatially performed.

Next, a temporal and/or spatial random dithering apparatus according to another exemplary embodiment of the present invention will now be explained with reference to diagrams illustrating a structure of the apparatus. The dithering apparatus may be described as including a mask circuit block for generating a dithering mask pattern and a dither circuit block for dithering.

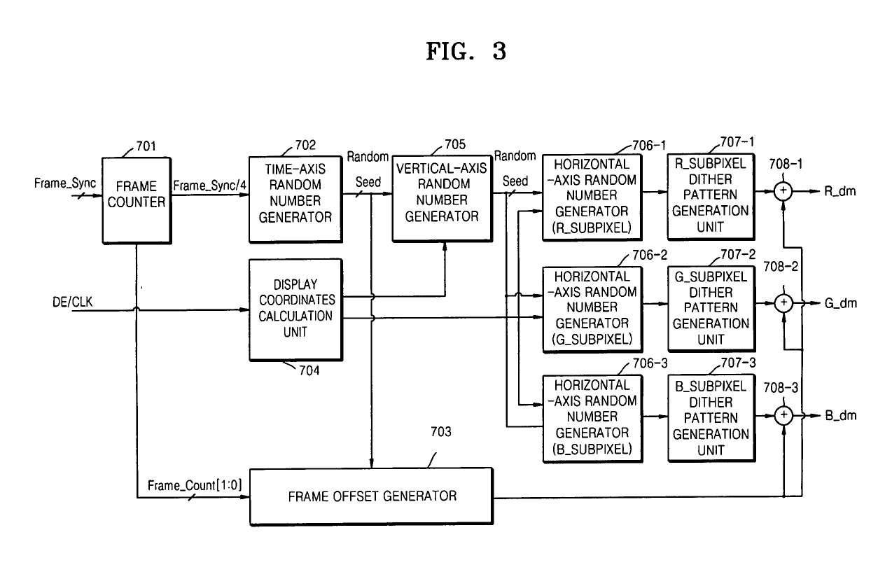

As illustrated in FIG. 3, the mask circuit block may include a frame counter 701, a time-axis random number generator 702, a frame offset generator 703, a display coordinates calculation unit 704, a vertical-axis random number generator 705, horizontal-axis random number generators 706-1, 706-2, and 706-3 for the R, G, and B subpixels, dither pattern generation units 707-1, 707-2, and 707-3 for the R, G, and B subpixels, and a plurality of adders 708-1, 708-2, and 708-3. Also for convenience, FIG. 3 extends the example circumstance, introduced above, wherein a frame offset value (K) is generated for each frame in the 2^{N} frame cycle, e.g., for four frames.

The frame counter 701 may receive an input of a frame synchronization signal (Frame_Sync), and may generate a first signal for every four frames. In the case of a dithering apparatus for converting an M-bit subpixel signal into an (M−N)-bit subpixel signal, where M and N are positive integers and M>N, a first signal may be generated in every 2^{N} frames. The time-axis random number generator 702 may generate a time-axis random number whenever a first signal is input.

The frame offset generator 703 may select one from among a plurality of frame offset values, based on the time-axis random number, and may output the selected value. In the case of a dithering apparatus for converting an M-bit subpixel signal into an (M−N)-bit subpixel signal, one value from amongst the set {0, 1, 2, to 2^{N}−1} may be selected as a frame offset value based on a time-axis random number, and may be output. For example, in the case of a dithering apparatus for converting 8-bit data into 6-bit data, one value from amongst the set {0, 1, 2, 3} may be selected as a frame offset value.

The display coordinates calculation unit 704 may receive a data enable signal (DE) and a data processing clock signal (CLK), and may count the clock signal (CLK) from a time when the data enable signal (DE) is generated, thereby calculating the display coordinates (x,y). The vertical-axis random number generator 705 may receive the display coordinate values, and may generate a random number whenever a line is changed.

The horizontal-axis random number generators 706-1, 706-2, and 706-3 for the R, G, and B subpixels may generate random numbers, respectively, e.g., at a rate of one random number for each macro pixel in a given frame, based on the random number output from the vertical-axis random number generator 705. In the case of a dithering apparatus for converting an M-bit subpixel signal into an (M−N)-bit subpixel signal, the size of the macro pixel unit may be determined as 2^{N/2}*2^{N/2} pixels. For example, in a dithering apparatus for converting 8-bit data into 6-bit data, the size of the macro pixel unit may be determined as 2×2 pixels.

The dither pattern generation units 707-1, 707-2, and 707-3 for the R, G, and B subpixels may generate random dithering patterns (also referred to as “mask patterns”), based on the random numbers generated for the macro pixels by the horizontal-axis random number generators 706-1, 706-2, and 706-3, respectively. In the case of dithering for converting an M-bit subpixel signal into an (M−N)-bit subpixel signal, in order to generate a dithering mask pattern, each of the dither pattern generation units 707-1, 707-2, and 707-3 may generate a masking pattern by randomly selecting one value from amongst the set {0, 1, 2, to 2^{N}−1}, as a mask value corresponding to each subpixel in each 2^{N/2}*2^{N/2} macro pixel in the first frame from which a 2^{N} frame cycle begins, so that the selected values do not overlap. Then, each of the dither pattern generation units 707-1, 707-2, and 707-3 may randomly select one value from amongst the remaining values {0, 1, 2, to 2^{N}−1}, excluding the value selected for the subpixel at the identical coordinates of the previous frame included in the 2^{N} frame cycle, as a mask value corresponding to each subpixel at the same coordinates of the 2^{N}−1 frames following the first frame.

As an example, in a context of converting 8-bit data into 6-bit data, operations of the dither pattern generation units 707-1, 707-2, and 707-3 will now be explained in detail with reference to FIG. 1. It is assumed that a macro pixel is formed, e.g., of 2×2 pixels.

The dither pattern generation units 707-1, 707-2, and 707-3 may generate arbitrary pattern values of each macro pixel according to a random numbers provided for each macro pixel, by using the function f: X→Y. In this case, the function f may have the domain X={aₙ, bₙ, cₙ, dₙ} and the codomain Y={0, 1, 2, 3}, in which the domain and the codomain have a 1:1 correspondence relation. Accordingly, a masking pattern may be generated so that no overlapping pattern value exists amongst the subpixels of a macro pixel.

According to this method, for example, it may be assumed that the masking pattern values of the first macro pixel {a₀, b₀, c₀, d₀} are randomly determined as {1, 0, 2, 3}. For the masking pattern values of the first macro pixel {a₁, b₁, c₁, d₁} of the second frame, any one value may be selected from amongst the remaining values excluding the value selected for the pixel at the same coordinates of the first frame, according to a random number. For the masking pattern value of the pixel a₁, any one value may be randomly selected from amongst the set {0, 2, 3}, excluding ‘1’ which is selected by the pixel a₀, and in the same manner, the masking pattern values of the pixels b₁, c₁, and d₁ may be determined. For example, it is assumed that the masking pattern values of the first macro pixel {a₁, b₁, c₁, d₁} of the second frame may be randomly determined as {0, 3, 1, 2}.

Then, for the masking pattern values of the first macro pixel {a₂, b₂, c₂, d₂} of the third frame, any one value may be selected from the remaining values excluding the values selected for the pixels at the same coordinates of the first and second frames, according to a random number. For the masking pattern value of the pixel a₂, any one value may be randomly selected from amongst the set {2, 3}, excluding ‘1’ and ‘0’ which are selected for pixels a₀ and a₁, and in the same manner, the masking pattern values of the pixels b₂, c₂, and d₂ may be determined. For example, it is assumed that the masking pattern values of the first macro pixel {a₂, b₂, c₂, d₂} of the third frame may be randomly determined as {2, 1, 3, 0}. Then, the masking pattern values of the first macro pixel {a₃, b₃, c₃, d₃} of the fourth frame may be automatically determined as {3, 2, 0, 1}.

For example, the dither pattern generation units 707-1, 707-2, and 707-3 may be implemented so that dither pattern information corresponding to a random number may be read from a dither table storing dither patterns satisfying a condition that the spatial mean and/or temporal mean of an image signal before dithering matches the spatial mean and/or temporal mean of the image signal after dithering, respectively.

The dither pattern generation units 707-1, 707-2, and 707-3 may add the generated masking pattern value for each coordinate to the frame offset value generated in the frame offset generator 703, thereby generating a dithering mask pattern. If a macro pixel is formed of 2^{N/2}*2^{N/2} pixels, each of the adders 708-1, 708-2, and 708-3 may be formed by 2N-ary adders, and carries may be ignored. For example, if the masking pattern values of the first macro pixel {a0, b0, c0, d0} of the first frame of a red subpixel signal are {1, 0, 2, 3} and a frame offset value is ‘2’, then the dithering mask pattern values may be {3, 2, 0, 1}. The dithering mask pattern for each of R, G, and B subpixels may be temporally and/or spatially randomly generated according to the operations described above.

Each of the time-axis random number generator 702, the vertical-axis random number generator 705, and the horizontal-axis pattern generators 706-1, 706-2, and 706-3 may be implemented by using shift registers and logic gates. For example, as seed data, the vertical-axis random number generator 705 may load a random number generated by the time-axis random number generator 702 into a shift register (not shown), thereby generating a random number. As seed data, each of the horizontal-axis pattern generators 706-1, 706-2, and 706-3 may load a random number generated in the vertical-axis random number generator 705 in a shift register (not shown), thereby generating random numbers. For example, when loading the data in the shift register, an endian-swapping method, which is a well-known technology, may be used so that correlations may be reduced, if not minimized.

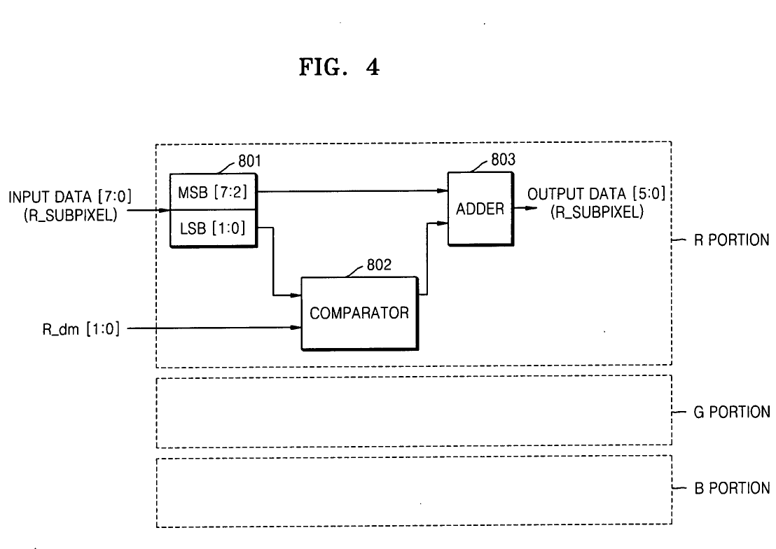

Next, an apparatus for dithering that uses the dithering mask pattern values (R_dm, G_dm, B_dm) for R, G, and B generated in the mask circuit block illustrated in FIG. 3 will be explained with reference to FIG. 4. For convenience of explanation, FIG. 4 illustrates in detail only an R portion of the dither circuit block that operates upon the R subpixel signal. Corresponding G and B portions of the dither circuit that would operate upon the G and B subpixel signals may be identical to the R portion. Also for convenience, FIG. 4 extends the example circumstance, introduced above, in which 8-bits are converted into 6-bits.

As illustrated in FIG. 4, the R portion of the dither circuit block may include a data separator 801, a comparator 802, and an adder 803. In a dithering apparatus for converting an M-bit subpixel signal into an (M−N)-bit subpixel signal, the data separator 801 may separate the input M-bit subpixel signal into most significant bits (MSBs) [M−1:N] and LSBs [N−1:0], and may output the separated signals. For example, when an 8-bit subpixel signal is converted into a 6-bit subpixel signal, the data separator 801 may separate the input data [7:0] into MSBs [7:2] and LSBs [1:0].

The comparator 802 may compare, for example, the values of LSBs [1:0] of the input data of an R_subpixel signal with the values of R_dm [1:0] which are the dithering mask pattern of the coordinates at which the input data is to be displayed, If the values of the LSBs [1:0] of the input data are greater than R_dm [1:0], then the comparator 802 may output ‘1’. Otherwise, the comparator 802 may output ‘0’. The adder 803 may add the value output from the comparator 802 to the LSB of the MSBs [7:2] separated in the data separator 801, thereby finally outputting a 6-bit subpixel signal. In this way, dithering may be randomly temporally and/or spatially performed.

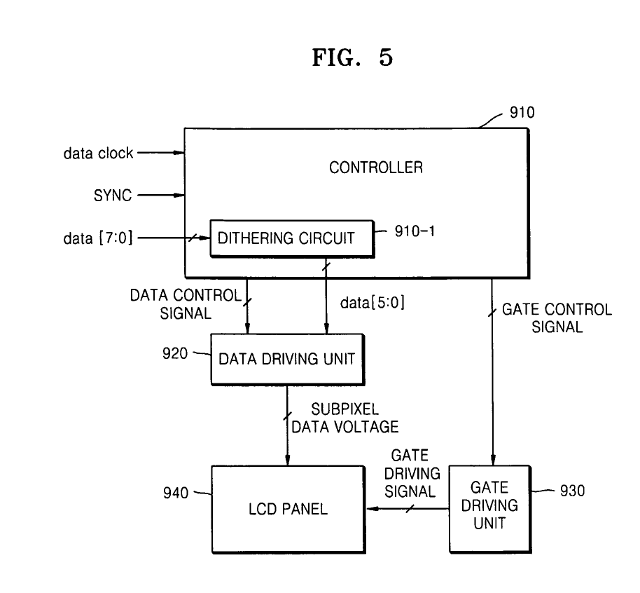

Next, a liquid crystal display (LCD) to which an apparatus for temporal and/or spatial random dithering is applied, according to another embodiment of the present invention, will be explained with reference to FIG. 5.

As illustrated in FIG. 5, the LCD may include a controller 910, including a dithering circuit 910-1, a data driving unit 920, a gate driving unit 930, and an LCD panel 940. The dithering circuit 910-1 may be formed in the same manner as the circuits illustrated in FIGS. 3 and 4. For example, when 8-bit pixel data is input and processed as 6-bit data in the data driving unit 920, the dithering circuit 910-1 may randomly temporally and/or spatially generate a dithering mask pattern that satisfies a condition in which the spatial mean and/or temporal mean of an image signal before dithering matches with the spatial mean and/or temporal mean of the image signal after dithering, respectively. Then, by using the thus generated dithering mask pattern, 8-bit data may be dithered into 6-bit data.

The controller 910 may receive inputs of a data processing clock signal (CLK) and a variety of synchronization signals, may generate a variety of data control signals required for driving data, and also may generate gate driving control signals required for driving gates. The gate driving unit 930, which may be connected to the gate lines of the LCD panel 940, may generate a gate driving signal, which may be formed by a combination of a gate on signal and a gate off signal, according to the gate control signal provided from the controller 910, and may provide the gate driving signal to each gate line. The data driving unit 920, which may be connected to the data lines of the LCD panel 940, may generate a voltage corresponding to a subpixel signal value output from the dithering circuit 910-1 of the controller, and may provide the voltage to the corresponding data line.

The LCD panel 940 may have a structure in which LCD devices in macro pixels are connected to a plurality of gate lines and data lines in the form of a matrix. Whenever a driving pulse is provided to the gate line, a pixel data voltage may be provided to the data line is provided to the LCD device, thereby expressing an image.

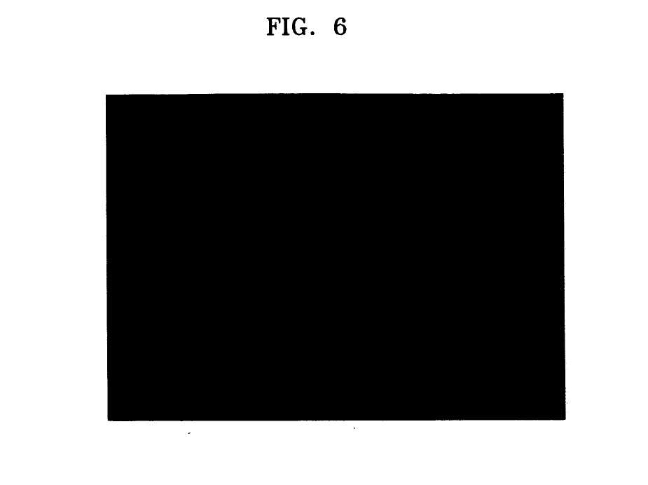

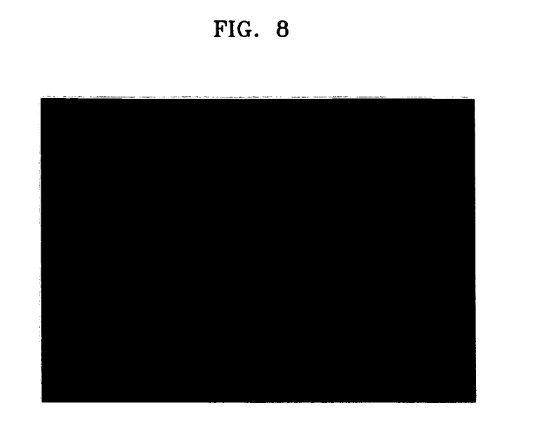

Differences between when dithering is applied to a gradation pattern according to the comparative example of the conventional technology, as in FIG. 8, and according to an exemplary embodiment of the present invention, as illustrated in FIG. 6, may be seen by comparing FIGS. 6 and 8. By inspection, the gradation achieved in FIG. 6 is finer and/or more subtle than the gradation achieved in FIG. 8. Furthermore, instances of a type of distortion pattern, referred to as a net pattern, can be observed in FIG. 8, whereas substantially no such net patterning can be observed in FIG. 6.

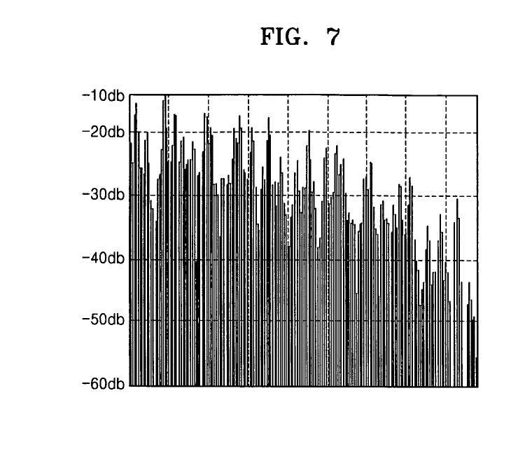

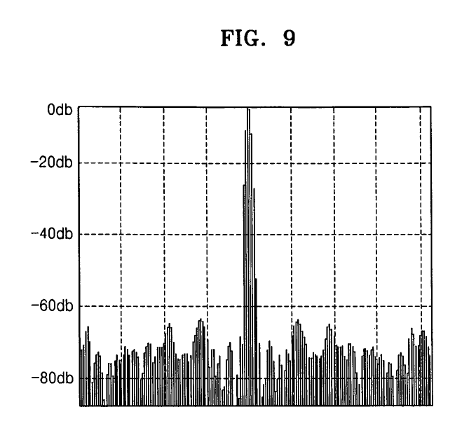

Differences between when dithering is applied to a gradation pattern according to the comparative example of the conventional technology, as in FIG. 9, and according to an exemplary embodiment of the present invention, as illustrated in FIG. 7 may be seen by comparing FIGS. 7 and 9. By inspection, relative to a pixel at a given fixed position, energy is concentrated in a predetermined frequency band in FIG. 9 whereas energy is not concentrated in a predetermined frequency band in FIG. 7. Rather, energy is more evenly distributed over an entire frequency band in FIG. 9.

According to at least one embodiment of the present invention as described above, dithering may be randomly temporally and/or spatially performed while satisfying the condition that the spatial mean and/or the temporal mean of an image signal before dithering matches the spatial mean and/or temporal mean of the image signal after dithering, respectively. In this way, concentration of an energy spectrum at a given frequency may be reduced, if not prevented. Therefore, the flicker problem due to conventional dithering may be reduced, if not prevented.

At least one embodiment of the present invention may also be embodied as computer readable data including executable instructions that are recorded on a computer readable recording medium. The computer readable recording medium is any data storage device that can store the data, including the executable instructions, and which can be read by a computer system so as to provide the computer system with the executable instructions included in the recorded data for execution. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium may also be distributed over network coupled computer systems so that the computer readable code is stored and executed in a distributed fashion.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made therein without departing from the spirit and scope of the present invention as set forth in the following claims.

What is claimed is:

1. A method of at least one of temporally and spatially randomly dithering by which an input M-bit subpixel signal is converted into an (M−N)-bit subpixel signal, the method comprising:
at least one of spatially and temporally randomly generating a dithering mask pattern satisfying a condition that a spatial mean and/or a temporal mean of an image signal before dithering matches a spatial mean and/or a temporal mean of the image signal after dithering, respectively; and
converting the M-bit subpixel signal into the (M−N)-bit subpixel signal using the dithering mask pattern.

2. The method as claimed in claim 1, wherein a frame is organized into macro pixels, each macro pixels including pixels, each pixel including subpixels, N being an integer and N>2, and at least one of spatially and temporally randomly generating the dithering mask pattern includes:
temporally randomly generating a frame offset value for each frame of 2^{N} frames;
generating a masking pattern by performing at least the following,
randomly selecting a respective value from a set {0, 1, 2, . . . , 2^{N}−1} as a mask value corresponding to each subpixel in each macro pixel in a first frame from which the cycle begins, such that the selected mask value does not overlap another mask value in a given macro pixel, and then
randomly selecting values, for the 2^{N}−1 remaining frames of the cycle and respective of coordinates of corresponding subpixels in the 2^{N} frames of the cycle, from remaining values in the set {0, 1, 2, . . . , 2^{N}−1} as mask values corresponding to each subpixel, excluding values already selected for subpixels at corresponding coordinates of other frames of the cycle, and such that selected mask values for a given macro pixel in a given one of the 2^{N}−1 remaining frames do not overlap; and
forming a 2^{N}-ary dithering mask pattern, by adding the frame offset value to the generated masking pattern.

3. The method as claimed in claim 2, wherein generating the frame offset value includes randomly selecting from the set {0, 1, 2, to 2^{N}−1}.

4. The method as claimed in claim 2, wherein a carry value generated when an addition is performed is discarded.

5. The method as claimed in claim 2, wherein generating the frame offset generation comprises:
generating a first signal for each 2^{N} frame synchronization signal;
generating a random number whenever the first signal is generated; and
generating the frame offset value based on the random number generated by the time-axis random number generator.

6. The method as claimed in claim 1, wherein the converting of the M-bit subpixel signal into the (M−N)-bit subpixel signal comprises:
comparing values of N least significant bits (LSBs) of the input M-bit subpixel signal with the values of the dithering mask pattern corresponding to coordinates at which the input subpixel signal is to be displayed;
adding ‘1’ to an (N+1)^{th} LSB of the input subpixels if the comparison result indicates that the values of the N LSBs of the input M-bit subpixel signal are greater than the values of the dithering mask pattern corresponding to the coordinates at which the input subpixel signal is to be displayed, else adding ‘0’ to the (N+1)^{th} LSB; and
deleting the values of the N LSBs in the resulting M-bit subpixel signal, thereby generating the (M−N)-bit subpixel signal.

7. A computer readable recording medium comprising instructions recorded thereon, execution of which by a computer results in the computer performing the method as claimed in claim 1.

8. An apparatus for at least one of temporally and spatially randomly dithering to facilitate converting an M-bit input subpixel signal of a frame into an (M−N)-bit subpixel signal, the apparatus comprising:
a dithering mask-pattern generation circuit configured to generate, by at least one of spatially and temporally randomly dithering, a dithering mask pattern satisfying a condition that a spatial mean and/or a temporal mean of an image signal before dithering matches a spatial mean and/or a temporal mean of the image signal after dithering, respectively; and
a dithering circuit converting the M-bit subpixel signal into the (M−N)-bit subpixel signal using the generated dithering mask patterns.

9. The apparatus as claimed in claim 8, wherein the frame is organized into macro pixels, the apparatus further comprising:
a frame offset generation circuit temporally randomly generating a frame offset value for each frame of 2^{N} frames; and
a spatial random number generation circuit generating random numbers for each macro pixel of a frame, the dithering mask pattern being based on the frame offset value and the random number corresponding to the macro pixel.

10. The apparatus as claimed in claim 9, wherein the frame offset generation circuit comprises:
a frame counter counting a frame synchronization signal, thereby generating a first signal for each 2^{N} frame synchronization signal;
a time-axis random number generator generating a random number whenever the first signal is generated; and
a frame offset generator generating a frame offset value based on the random number generated by the time-axis random number generator.

11. The apparatus as claimed in claim 9, wherein the spatial random number generation circuit comprises:
a display coordinates calculation unit counting a data clock signal, thereby calculating display coordinates;
a vertical-axis random number generator generating a random number whenever a line is changed; and
a horizontal-axis random number generator generating the random numbers for each macro pixel based on the random number generated in the vertical-axis random number generator.

12. The apparatus as claimed in claim 11, wherein the horizontal-axis random number generator comprises a red subpixel signal horizontal random number generator, a green subpixel signal horizontal random number generator, and a blue subpixel signal horizontal random number generator.

13. The apparatus as claimed in claim 8, wherein the frame is organized into macro pixels, each macro pixel including pixels, each pixel including subpixels, N being an integer and N≧2, and the dithering mask pattern generation circuit comprises:
a frame offset generation circuit temporally randomly configured to generate a frame offset value frame of 2^{N} frames;
a dither pattern generation unit configured to generate a masking pattern based on the random number generated in the spatial random number generation circuit, by performing at least the following,
randomly selecting a respective value from a set {0, 1, 2, . . . , 2^{N}−1} as a mask value corresponding to each subpixel in each macro pixel in a first frame from which the cycle begins, such that the selected mask value does not overlap another mask value in a given macro pixel, and then
randomly selecting values, for the 2^{N}−1 remaining frames of the cycle and respective of coordinates of corresponding subpixels in the 2^{N} frames of the cycle, from the remaining values in the set {0, 1, 2, . . . , 2^{N}−1} as mask values corresponding to each subpixel, excluding values already selected for subpixels at corresponding coordinates of other frames of the cycle, and such that selected mask values for a given macro pixel in a given one of the 2^{N}−1 remaining frames do not overlap; and
an adder configured to add the frame offset value and the masking pattern values, respectively, thereby generating dithering mask pattern values.

14. The apparatus as claimed in claim 13, wherein the dither pattern generation unit may be configured to select and output one dither pattern, based on the random number output from the horizontal random number generator, from a table storing a plurality of dither patterns sized according to a size of the macro pixels.

15. The apparatus as claimed in claim 13, wherein the adder discards a carry value that occurs when the adder performs addition.

16. The apparatus as claimed in claim 8, wherein the dithering mask pattern generation circuit comprises a dithering mask pattern generation circuit for a red subpixel signal, a dithering mask pattern generation circuit for a green subpixel signal, and a dithering mask pattern generation circuit for a blue subpixel signal.

17. The apparatus as claimed in claim 8, wherein the dithering circuit comprises:
a data separator dividing the input M-bit subpixel signal into most significant bits (MSBs) [M−1:N] and LSBs [N−1:0];
a comparator comparing the dithering mask pattern values with corresponding LSBs [N−1:0] of subpixels in the macro pixels, and if the values of the LSBs [N−1:0] are greater than the values of the dithering mask pattern, outputting ‘1’, else outputting ‘0’; and
an adder adding the output value of the comparator to the LSB of the MSBs [M−1:N], thereby outputting the dithered (M−N)-bit subpixel signal.

18. The apparatus as claimed in claim 8, wherein the dithering circuit comprises a dithering circuit for a red subpixel signal, a dithering circuit for a green subpixel signal, and a dithering circuit for blue subpixel signal.

19. A liquid crystal display (LCD) apparatus comprising:
an LCD panel in which a plurality of gate lines and a plurality of data lines are arranged intersecting each other in the form of matrix, the LCD panel being operable to display an image, in units of pixels, corresponding to a pixel data voltage provided to a data line according to a gate pulse provided to a gate line;
a controller configured to perform at least the following,
generating a gate control signal for selecting the gate line and a data control signal for outputting pixel data in units of data lines,
at least one of spatially and temporally randomly generating a dithering mask pattern satisfying a condition that a spatial mean and/or a temporal mean of an image signal before dithering matches a spatial mean and/or a temporal mean of the image signal after dithering, respectively, and
performing dithering using the dithering mask pattern, thereby converting the M-bit subpixel signal of a frame into the (M−N)-bit subpixel signal and outputting the converted signal;
a gate driving unit providing a gate driving pulse to a gate line selected according to the gate control signal; and
a data driving unit generating a voltage corresponding to the (M−N)-bit subpixel signal and providing the generated voltage to the data line.

20. The LCD apparatus as claimed in claim 17, wherein the controller comprises:
a frame offset generation circuit configured to temporally randomly generate a frame offset value in units of 2^{N} frames;
a spatial random number generation circuit configured to generate random numbers for each macro pixel of a frame;
a dithering mask pattern generation circuit configured to at least one of spatially and temporally randomly generate a dithering mask pattern for each macro pixel satisfying a condition that the spatial mean and/or the temporal mean of an image signal before dithering matches the spatial mean and/or the temporal mean of the image signal after dithering, respectively, based on the frame offset value and the random number corresponding to the macro pixel; and
a dithering circuit configured to convert the M-bit subpixel signal into the (M−N)-bit subpixel signal using the generated dithering mask pattern.
